(19) United States
(12) Patent Application Publication
(10) Pub. No.: US 2013/0238696 A1
(43) Pub. Date: Sep. 12, 2013

(54) SYSTEM AND METHOD FOR PRESENTING SYNCHRONIZED MEDIA IN A DIGITAL CONTENT ENVIRONMENT

(71) Applicant: Abel Cotelo, Coconut Grove, FL (US)

(72) Inventor: Abel Cotelo, Coconut Grove, FL (US)

(21) Appl. No.: 13/397,340

(22) Filed: Mar. 8, 2012

(51) Int. Cl. G06F 15/16

(52) U.S. Cl. 709/204

(57) ABSTRACT

A system and method for presenting synchronized media in a digital content environment is presented. In particular, the central synchronous management system is communicatively disposed relative to the content environment and structured to identify target media or user-generated media. Specifically, the target media is analyzed for patterns of occurrences, keywords, geo-location information, etc. to be used as searching criteria. Synchronous media is then located from within the content environment and external to the content environment, combined with the initial communication or target media and displayed.

### BACKGROUND OF THE INVENTION

1. Field of the Invention

The present invention is generally directed to a system and method for gathering synchronized media from various sources and formatting, presenting and/or displaying the synchronized media in a particular digital content environment (e.g., social networks, web or Internet forums, mobile text messages, electronic mail communications, and the like). Specifically, the synchronized media may include, but is not limited to, data, media or virtually any sort of information (including text, graphics, audio, video, or any combination thereof) that is at least partially related to or associated with an identified user event (e.g., a status update, text message, electronic mail communication, watching a video, listening to an audio track, or reading an article). The user event and the synchronized media are formatted, combined, and displayed in the content environment.

### DESCRIPTION OF THE RELATED ART

Electronic communication continues to rise as a dominant method of communication between people in today's society. In particular, this includes communication via a number of content environments such as Internet accessible social networks (such as FACEBOOK, TWITTER, or GOOGLE+), as well as text messages, SMS messages, electronic mail, instant messaging, Internet chat rooms, Internet forums, etc.

Accordingly, it would be beneficial to automatically, seamlessly and before the message is communicated, search for and identify, in real time, certain related or synchronous media relative to the message or communication. The searching would preferably be conducted both inside and outside of the particular content environment. Once identified, the synchronous media can be combined with the initial message or communication and delivered to a designated recipient or a number of recipients. It could be said that the content is synchronized with related or synchronous content that may be of interest to the recipient or other users. Traditionally, works about content synchronization have operated at two main levels: content synchronization between multiple devices, and really simple syndication (RSS). The first level has focused on the content that users can synchronize between devices, putting more emphasis on the device and content source than on the user preferences and activity. The later, has been more about allowing users to customize their content channels and about providing updates/news feed about a user and his/her relationships recent activities within a social network.

Accordingly, there is a need in the art for a system and method for automatically and seamlessly synchronize the initial communication or media with related media originating from within and external to the content environment.

### SUMMARY OF THE INVENTION

As will be described in the detailed description herein, the present invention is generally directed to a system and method for presenting synchronized media in a digital content environment. Specifically, the digital content environment of the various embodiments disclosed herein includes appropriate circuitry, hardware and/or software components to generate or manage one or more communication channels. In particular, the communication channel(s) or content environment(s) may include an interactive social network (e.g., FACEBOOK, TWITTER, GOOGLE+) enabling users to generate content, e.g., in the form of status updates, or enabling passive users to merely access, read or otherwise view the content without generating content. It should be apparent, however, that the content environment may include other communication channels including, but not limited to, web or Internet forums, web or Internet chat rooms, or electronic communications such as text messaging, electronic mail, facsimile, etc.

Furthermore, the various embodiments of the present invention are structured to identify and/or receive a user event or target media such as user-generated media or an identification of user activity. As just one example, the target media or event may include a status update, comment, text message, email, facsimile, or virtually any media communicated in or through the content environment. In addition, the target media or event may include an identification of user activity. The user activity may include viewing a video, listening to an audio track, etc. and therefore, the identification may include, for example, the title of the video or audio track, the meta tags associated with the video or audio track, a description of the video or audio track, etc.

Moreover, the present invention is further structured to analyze the user event or target media in order to extract or determine searching criteria. Specifically, the event or target media is analyzed to determine patterns of occurrences, keywords, geo-location information, and the like, that can be used to search for related or synchronous media. In particular, the system and method of the present invention is configured to search for synchronous media that is at least partially related to the user event. As will be apparent from the disclosure provided herein, the searching may be conducted within the content environment and/or outside of the content environment.

Once the synchronous media is identified or located, it is formatted, organized, and/or filtered, then displayed. In particular, the synchronous media may be scored or rated in accordance with or based upon the source of the media, the location of the media, the relevance of the media to the user event, etc. The synchronous media is then combined with the user event or target media and displayed to the first (generating) user, a second (recipient) user, or a plurality of other users.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of at least one embodiment of the system as disclosed herein.

FIG. 2 is a schematic representation of another embodiment of the system as disclosed herein.

FIG. 3 is an exemplary screenshot of a content environment as disclosed in accordance with at least one embodiment of the present invention.

FIG. 4 is a schematic block diagram of yet another embodiment of the synchronous environment of the present invention.

FIG. 5 is a schematic block diagram of a further embodiment of the synchronous environment of the present invention.

FIG. 6 is a high-level flow chart of the method as disclosed in accordance with at least one embodiment herein.

Like reference numerals refer to like parts throughout the several views of the drawings.

### DETAILED DESCRIPTION OF THE PREFERRED EMBODIMENT

As shown in the accompanying drawings, the present invention is directed to a system (generally referenced as 10) and a method (generally referenced as 100) for gathering or identifying synchronized media from various sources and formatting, presenting and/or displaying the synchronized media in a given digital content environment. In particular, as will be described in greater detail below, the present invention comprises at least one, but more practically a plurality of users 12 that utilize one or more user devices 14 to access a digital content environment 20 via an interactive network 15.

In particular, the user device(s) 14 of the various embodiments are structured and configured to communicate with one or more interactive or communication networks 15. In at least one embodiment, the interactive or communication network 15, as used herein, generally refers to a collection of networks commonly known as the World Wide Web. Specifically, the World Wide Web represents a collection of computer networks cooperatively connected to each other and accessed by virtue of the Internet Protocol or other like protocols. It is contemplated, however, that the communication network 15 includes virtually any computer, cellular, telephone, facsimile or other network, such as, for example, a Wide Area Network (“WAN”), Local Area Network (“LAN”), Intranet, peer-to-peer network, Blue Tooth network, WIFI, Intranet, mobile network, radio frequency systems, GSM, GSM plus EDGE, CDMA, quadband, VOIP, or any other suitable protocol(s).

Accordingly, the user device(s) 14 can include any suitable type of electronic or computing device, including a desktop, laptop, netbook, or tablet computer. In addition, the user device(s) 14 may include a cellular or mobile telephone, a hand-held multi-media device, a dedicated email device, a personal data assistant (“PDA”), a handheld, portable or substantially fixed gaming device, a facsimile machine, etc. In particular, the user devices 14 may comprise control circuitry, a storage device, memory, input/output (“I/O”) circuitry, communications circuitry, and a display (not shown). In some embodiments, the user devices 14 can include other components such as a power supply, battery, global positioning system (GPS), one or more cameras, a microphone, a speaker, etc.

Moreover, the various users 12 of the present invention utilize the user devices 14 in order to access or communicate within the digital content environment 20. Specifically, the digital content environment 20, as used herein includes appropriate circuitry, hardware and/or software to generate or manage one or more communication channels available or used by one or more users 12. In particular, the communication channel or content environment 20 may include an interactive social network, including but not limited to FACEBOOK, TWITTER, GOOGLE+, etc. enabling users 12 or active members of the social network to generate content, e.g., in the form of status updates, or enabling passive users to merely access, read or otherwise view the content without generating content.

In addition, however, the content environment 20 of the present invention may include other communication channels and is in no way limited to social networks. For example, the content environment 20 may also or instead include web or Internet forums, web or Internet chat rooms, or electronic communications such as text messaging, electronic mail, facsimile, etc. Accordingly, the content environment 20 of the various embodiments of the present invention includes the various hardware and software components structured to implement the communication channel(s). As such, the content environment 20 may include one or more email servers, text messaging servers or relay hardware, Internet or web servers, databases, control networks, etc.

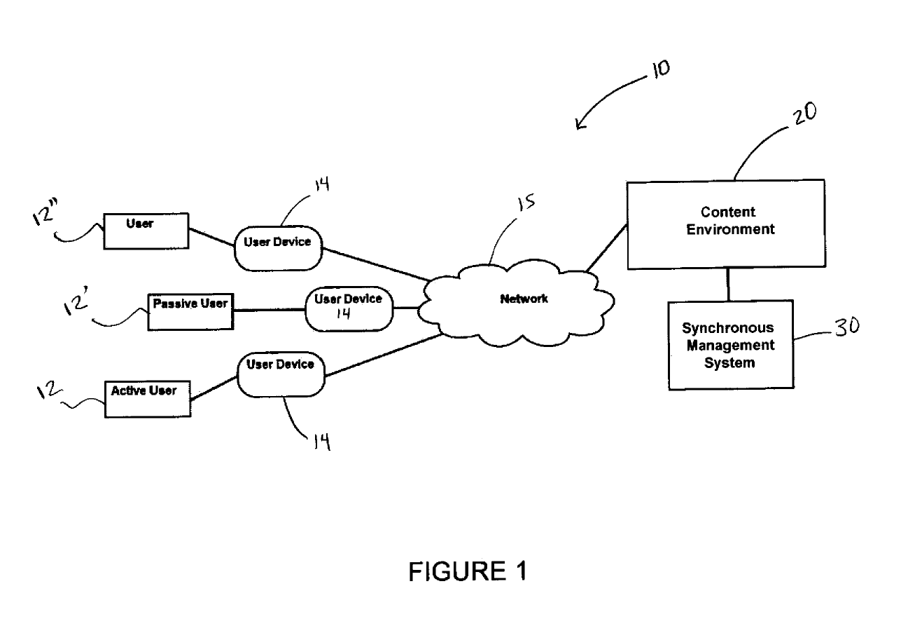

Furthermore, as illustrated in FIG. 1, at least one embodiment of the present invention further comprises one or more central synchronous management systems 30 disposed in a communicative relation with the network 15 and/or the content environment 20. As will become apparent from the disclosure herein, the central synchronous management system 30 is structured to receive or identify a user or target event, search for or identify synchronous content related to the target event, and display or cause the display of the synchronous content in the manner disclosed in accordance with at least one embodiment of the present invention. Accordingly, the central synchronous management system 30 of the various embodiments of the present invention comprises certain hardware and/or software including, for example, one or a plurality of computers, workstations, servers, databases or other computing and processing devices, along with specifically structured or implemented synchronous engines or software applications, structured to facilitate implementation of the present invention in the intended manner as disclosed herein.

It should be noted that the central synchronous management system 30 may, in at least one embodiment, share common hardware or otherwise be a part of or affiliated with the content environment 20 itself in that the content environment 20 may be specifically structured to implement the synchronization of media as disclosed herein. However, in other embodiments, existing social networks, communication channels or other content environments 20 may be communicatively disposed with a separate synchronous management system 30 to implement the features presented herein.

In particular, the system 10 and/or the central synchronous management system 30 of the present invention is structured to identify a first user event conducted or disposed within the content environment 20 or, at a minimum, at least partially within an accessible range of the content environment, as will be discussed below. Specifically, the first user event, as used herein, can include, in one embodiment, user-generated content 40 or target media (e.g., a status update, text message, email, or web post) specifically generated by the user 12 or, in other embodiments, user activity (e.g., viewing a video, listening to an audio track, or reading an article).

In the case where the user event or target media includes user-generated content 40, the content or media may include virtually any form of electronic information or data, such as, textual data, multimedia, video, animation, audio, visual-audio, or any combination thereof. The user-generated content 40 is preferably conducted or disposed within the content environment 20. For instance, in the embodiment where the content environment 20 is an Internet-accessible social network, the user-generated content 40 may be in the form of a status update, a post or comment on a “friend's” wall, a post or comment on a photograph, a post or comment on an existing comment or status update, etc. As discussed above, however, in other embodiments, the content environment 20 may include other communication channels, and thus the user-generated content 40 may include, but is certainly not limited to, text messages, e-mail messages, posts on an Internet or web forum, activity in an Internet or web chat room, facsimile transmissions, etc.

In yet another embodiment, the first user event or target media may include user activity, such as a user 12 viewing an online video, listening to an audio track, reading an article, visiting a website, etc. In such an embodiment, if the activity is conducted within the content environment 20, e.g., if the user is viewing a video or other media within a social network or on an Internet web form, then the central synchronous management system 30, which may be a part of or disposed in a communicative relation with the content environment 20, may identify the activity or target media, as disclosed herein. It is contemplated however, that the user activity may be conducted outside of the specific content environment 20, yet still be accessible or identifiable thereto. For example, a user belonging to a social network (content environment) may decide to view a video on a separate web site (e.g., YouTube) or read an article on a separate web site (e.g. www.cnn.com). In certain embodiments, and depending on certain privacy settings, the user 12 may authorize the social network (content environment) to monitor the user's activity on other web sites. In such a case, the content environment 20 of at least one embodiment may be structured and authorized to identify user activity conducted outside, yet within an accessible range, of the content environment 20.

In certain embodiments wherein the user event is user-generated content 40, the user-generated content may be communicated to or otherwise received by the central synchronous management system 30. In this manner, central synchronous management system 30 can analyze the content 40, as will be described below. However, in at least one embodiment, the entire content 40 or media is not communicated to central synchronous management system 30, for example, in cases wherein the user event includes viewing of a large video file or a lengthy audio track. In such a case, an identification of the content (e.g., title, meta tags, short description, certain parsed out words or content) may be communicated to or received by central synchronous management system 30 for analysis.

Either way, the central synchronous management system 30 is structured and configured to analyze the event to extract, generate or otherwise identify searching criteria which will be used to identify synchronous media, as will be discussed below. For example, upon analyzing the target event, the central synchronous management system 30 may extract different sorts of searching criteria, including, but in no way limited to words, phrases, pixels, portions of an image, an entire image, portions of a video, and entire videos, the title or meta tags associated with an image or video, the title or meta tags associated with an audio track, portions of an audio track, location information (e.g., the location of the user generating the content, the location of the user 12 conducting the activity, the location of certain items or establishments mentioned in the content, etc.) Specifically, and for exemplary purposes only, the central synchronous management system 30 may extract the identification of a restaurant or other establishment, landmark, etc., from a status update or video that a user is watching, a number of keywords from the user's post, and the location of the user via the geo-location hardware and/or software on the user's device 14. From the identification of the restaurant, the central synchronous management system 30 may be able to identify the location of the restaurant via external or web searching capabilities. In addition, the searching criteria identified or extract by the central synchronous management system 30 may further include patterns of occurrences in the target media and/or information obtained from the user's profile, address book, etc. For example, information about the user (e.g., the user's location, work place, work profession, schools attended, likes and dislikes, etc.) could be extracted by the central synchronous management system 30 and used as searching criteria.

Using the extracted or generated searching criteria, the central synchronous management system 30 is structured to search for synchronous media 42 that is at least partially related to the user event or target media, or synchronous media that otherwise meets or satisfies the searching criteria based upon one or more searching and comparison algorithms.

In at least one embodiment, the central synchronous management system 30 is capable of and structured to search within the given content environment 20 for synchronous media 42. For instance, in the event the content environment is a social network, using the searching criteria, the central synchronous management system 30 will search for items within the social network that match, meet or at least partially satisfy the search criteria. The items within the social network that may be extracted include, but are not limited to, other user comments, posts, or status updates, photographs, videos, audio tracks uploaded into the social network (either by the active or target user 12 or by a different user), stories, articles, or events disposed within the social network, etc. Of course, the content environment 20 is not limited to social networks and thus, the synchronous media 42 extracted, identified or gathered by the central synchronous management system 30 may include email messages, contacts in the user's address book, other text messages, etc.

In addition to searching within the content environment 20 (e.g. for internal synchronous media), the central synchronous management system 30 of certain embodiments of the present invention is further structured to search outside of the content environment 20 (e.g. for external synchronous media). For instance, and again using the searching criteria extracted from the target media or user event, the central synchronous management system 30 may search on other pre-designated or pre-authorized web sites or may conduct a global Internet web search for synchronous media 42. In particular, the central synchronous management system 30 may connect to other pre-designated web sites to search for related articles, photos, images, audio tracks, or virtually any data, information or media that may be synchronous media, i.e., media at least partially related to the user event, target media or searching criteria. In other embodiments, the central synchronous management system 30 may use search engines, such as known search engines (e.g., Google, Yahoo, Ask, etc.) or other global web searching modules, to search for or identify other synchronous media 42. In any event, the searching may be conducted in real-time, leading to real-time identification, format and display of synchronous media. Specifically, the central synchronous management system 30 of certain embodiments is structured to search (internally and/or externally) immediately upon identification of the target media or event, allowing the subsequent display of the synchronous media to occur quickly, instantaneously and in real-time.

Moreover, in at least one embodiment, the present invention further comprises formatting or organizing the (internal and/or external) synchronous media 42 prior to the display or communication of the synchronous media 42 to either the first user 12, a designated recipient 12′, or other user's 12″. For instance, once the synchronous media 42 is identified or gathered, the amount of synchronous media 42 may be quite large. Of course, the searching algorithms may be tailored to only gather a certain amount of information or stop searching once certain information is found. However, in either case, the synchronous media 42 must be organized or formatted in a way for presentation to the users 12,12′,12″.

In one embodiment, the internal and external synchronous media 42 may be combined and globally sorted by relevance to the target media 40. Accordingly, the source of the synchronous media 42, in one embodiment, may not be analyzed upon the organization or formatting thereof. Rather, relevance or strength of commonality relative to the target media 40 is the only factor.

Of course other formatting or organizing algorithms are contemplated, and in particular, a preferred algorithm may organize the internal synchronous media separate from the external synchronous media and prioritize the internal synchronous media as higher or more relevant than external synchronous media. Within each category (internal and external), the synchronous media 42 may further be organized by relevance to the target media 40. In such an embodiment, the most relevant internal synchronous media would be displayed first, whereas the least relevant external synchronous media would be last on the list.

As another example, each item of synchronous media 42 may be assigned a score based upon certain factors, including the source of the media, relevance of the media, etc. For instance, synchronous media 42 originating or coming from a user's close friend or contact within the content environment may get assigned a higher score than synchronous media coming from the user's acquaintance from within the content environment, which may get a higher score than synchronous media coming from a stranger from within the content environment, which may get a high score that synchronous media coming from a source external to the content environment. Similar scoring techniques or algorithms may be applied to the synchronous media 42 based upon relevance to the target media 40.

Furthermore, the central synchronous management system 30 is structured to display or cause the display of the synchronous media 40. For instance, in at least one embodiment, the synchronous media 40 is combined with the target media 40 and displayed within the content environment 20, e.g., in the form of a status update, comment, text message, email, etc.

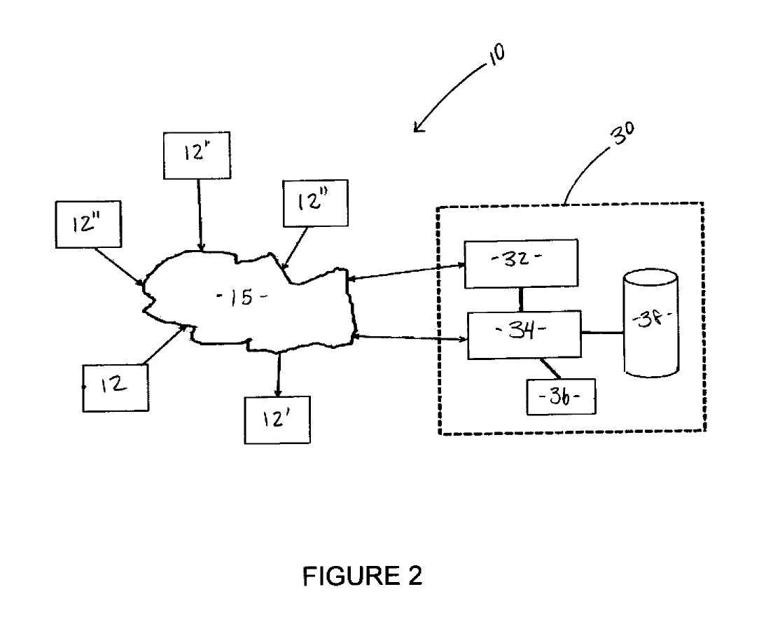

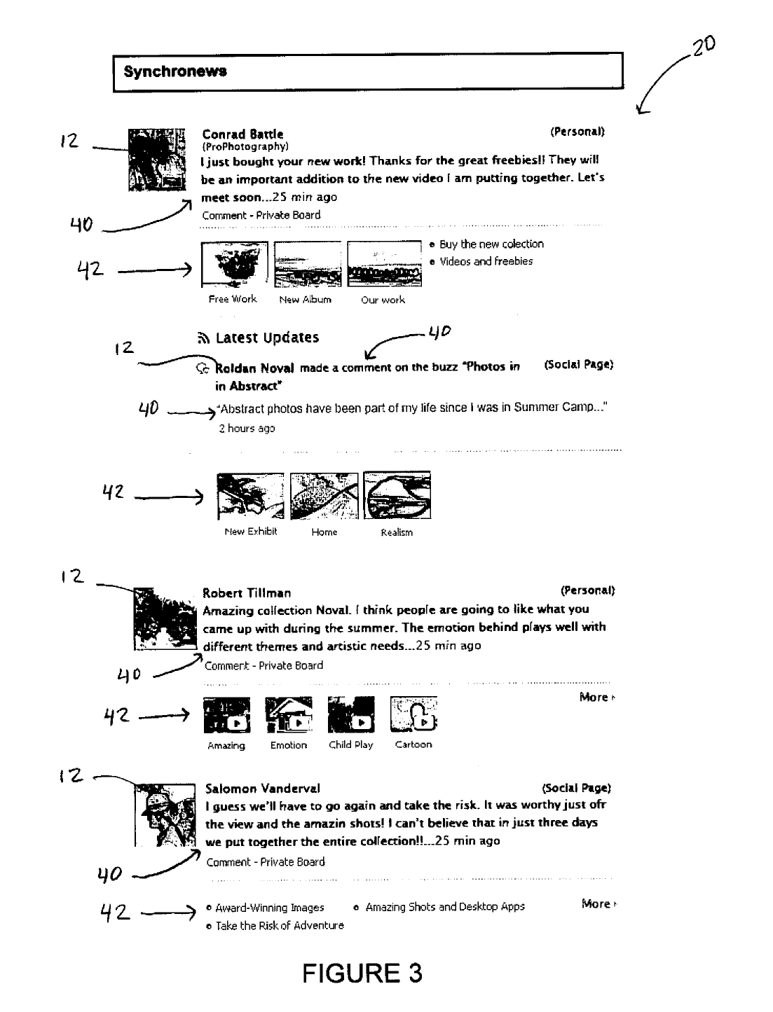

Referring to the exemplary embodiment illustrated in FIG. 2, the synchronous media 42 is combined with the corresponding target media 40 for each of the users and the target media 40 and synchronous media 42 are simultaneously displayed within the news feed on the social network. The synchronous media 42, as shown in FIG. 3, is displayed beneath the associated target media 40, and in the form of a link or clickable item. Of course, this is merely exemplary, and depending upon the content environment 20, the combination of the target media 40 and synchronous media 42 may be different. For example, in the embodiment wherein the content environment 20 includes text messaging, the text message may have the target media (e.g., the user-generated text message) on one portion of the screen or display (e.g. top, middle, bottom), whereas the synchronous media 42 is displayed on a different portion of the screen (e.g., bottom, outer edges, top).

It should be apparent that the combined target media 40 and synchronous media 42 may be displayed generally to a group of “friends” or publicly (e.g., via a status update, comment, post, etc.) or communicated to a specific designated recipient (e.g., via a private message, text message, email, or facsimile). Accordingly, the displaying or communicating of the target media 40 and synchronous media 42 may depend on the particular situation or content environment 20, and thus may be displayed to the public, a group of users, one or more designated recipients, and/or the first user 12.

Referring to FIG. 2, the central synchronous management system 30 of at least one embodiment may comprise a number of components, mechanisms, or modules collectively structured to function in the intended manner of the central synchronous management system 30 described herein. In particular, the central synchronous management system 30 of one embodiment may comprise an activity or application processor 32 which is structured to receive the target media 40 and/or an identification thereof. Particular, instead of posting or communicating the target media immediately, the target media 40 is transmitted to a synchronous media generator 34, which is structured to extract patterns of occurrences, identify key words, and other searching criteria, as described above, and search for synchronous media 42. In one embodiment, the central synchronous management system 30 further comprises a relational module 36, which includes appropriate circuitry and software to create synonyms or other related criteria similar to the extracted keywords, etc. In this manner, the searching criteria can be expanded to include additional words, phrases, images, audio, etc. in order to identify further synchronous media 42. Still referring to FIG. 2, the central synchronous management system 30 of one embodiment may further comprises a storage unit 38 and/or database structured to store and maintain certain synchronous media 42 for quick and ready access on other subsequent searches. For instance, the searching step may include (in addition to searching within the content environment 20 and outside the content environment 20) searching within the storage unit 38 for previously identified synchronous media 42. This can significantly reduce the time between the generation of the target media and the communication or display of the combined target media 40 and synchronous media 42.

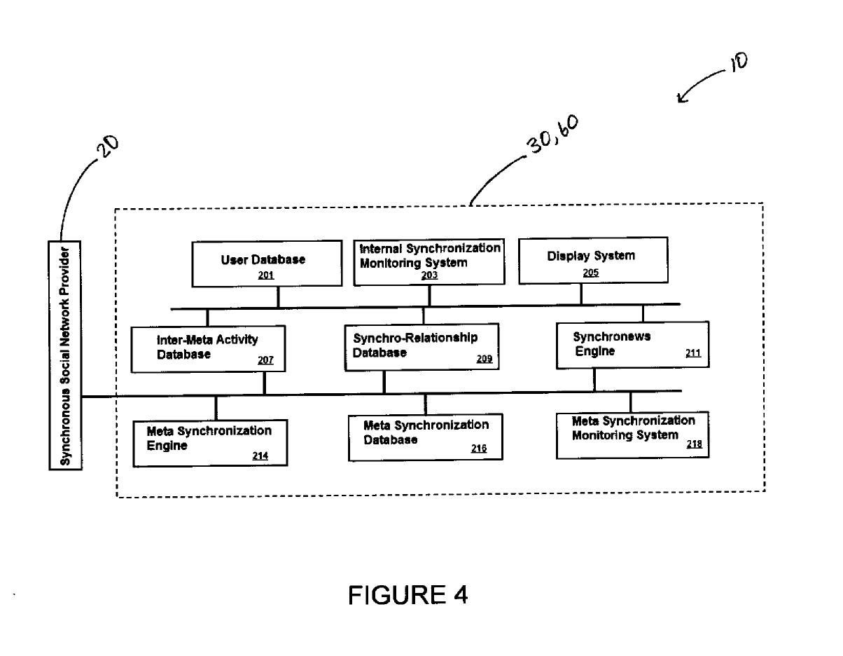

Referring now to the embodiment illustrated in FIG. 4, the central synchronous management system 30 is disposed in a communicative relation with the content environment 20 (in the illustrated embodiment, synchronous social network provider). The central synchronous management system 30 of this embodiment comprises a plurality of different components, each of which may be separate hardware and software components, but in a preferred embodiment, each of the illustrated components comprise separate software modules which may or may not share common hardware components.

In particular, user database 201 comprises a storage unit or database structured to store user information, profiles, user pages, templates, and user-generated content 40 within the content environment 20 or synchronous environment 60. In addition, the synchronous environment 60 or central synchronous management system 30 further comprises an internal synchronization monitoring system 203 which is structured and configured to monitor, search and/or analyze the media and/or activity conducted within the synchronous environment 60 or within the content environment 20. Display system 205 is structured to organize, format, combine and display the target media 40 and synchronous media 42 as disclosed herein.

Further, and still referring to FIG. 4, inter-media activity database or storage unit 207 is structured to store the user-generated activity produced within the content or synchronous environments 20, 30 in an intelligent relational manner relative to the content outside of the environments 20, 30. Synchro-relationship database is structured to store the relationships among the users, media and activity within the environments 20,30 in relational manners relative to the media or content outside of the environments 20,30. The synchronews engine 211 is structured to search for and provide the synchronous media 42 as disclosed herein.

Moreover, the met synchronization engine 214 provide the synchronized media outside of the environments 20,30. Meta synchronization database stores the synchronized media from outside of the environments 20,30, and the meta synchronization monitoring system monitors the activity and media outside of the environments 20,30.

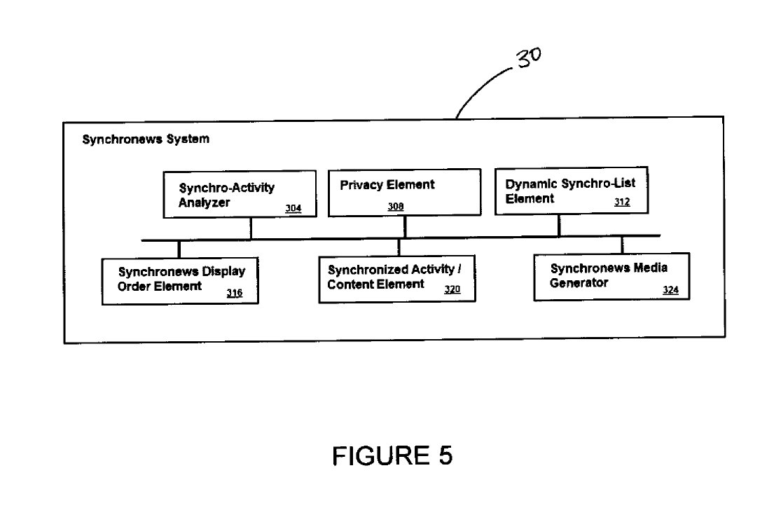

Turning now to FIG. 5, yet another embodiment of the central synchronous management system 30 is illustrated showing the communication of various components. In particular, synchro-activity analyzer 304 comprises appropriate circuitry and software to analyze the activity, content and media within the content environment in relation to the outside environment. Privacy element 308 takes into account the privacy settings in the synchronous and/or content environments in order to control access to the media. Dynamic synchro-list element 312 is structured to gather a list of synchronized dynamic content from within and external to the content and synchronous environments. Synchronews display order element 316 is structured to format, organize and display the internal and external synchronized activity, content and media. Synchronized activity/content element is structured to gather the internal and external synchronized media. Synchronized media generator 324 may be capable of generating or formatting certain internal and external synchronous media.

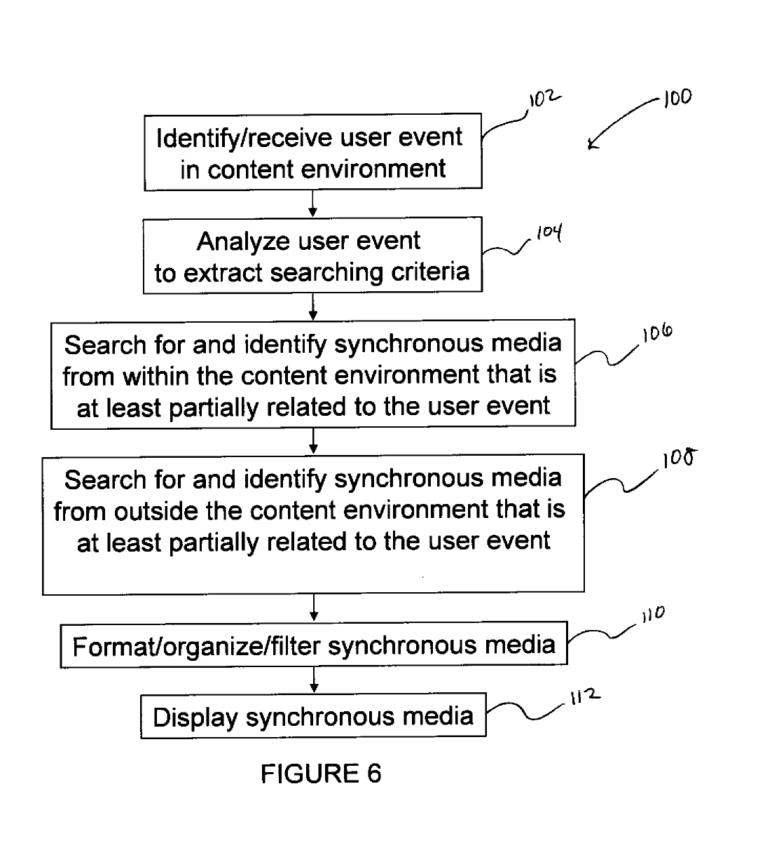

Referring now to FIG. 6, the present invention further comprises a method 100 for presenting synchronized media in a digital content environment using the various components, structures and modules disclosed and described in accordance with the system 10 herein. In particular, the method 100 includes identifying and/or receiving a user event in the content environment, as generally represented at 102. Specifically, the central synchronous management system is structured to identify or receive target media, such as user-generated media or an identification of user activity, as provided herein. As an example, the target media may include a status update, comment, text message, email, facsimile, or virtually any media communicated in or through the content environment. In addition, the target media may include an identification of user activity. The user activity, as mentioned above, may include viewing a video, listening to an audio track, etc. and therefore, the identification may include, for example, the title of the video or audio track, the meta tags associated with the video or audio track, a description of the video or audio track, etc.

Furthermore, the method 100 includes analyzing the user event in order to extract or determine searching criteria, as generally represented at 104. Specifically, the event is analyzed to determine patterns of occurrences, keywords, geolocation information, and the like, that can be used to search for related media. In particular, as shown at 106,108 the method further includes searching for synchronous media that is at least partially related to the user event. The searching may be conducted within the content environment (106) and/or outside of the content environment (108). In either event, the searching may be conducted in real-time, leading to real-time synchronization, meaning that the searching step is conducted immediately upon identification of the target media or event, allowing the display of the synchronous media to occur quickly, instantaneously and in real-time.

Once the synchronous media is identified or located, the method 100 further include formatting, organizing, and/or filtering the synchronous media, as at 110. In particular, the synchronous media may be scored or rated in accordance with or based upon the source of the media, the location of the media, the relevance of the media to the user event, etc. The synchronous media is then combined with the user event or target media and displayed to the first (generating) user, a second (recipient) user, or a plurality of other users, as shown at 112.

As one example, a user 12 may generate a status update or comment on another user's 12′ social network page or “wall” that reads or otherwise includes the phrase “Happy Birthday.” The system 10 and method 100 of the present invention will identify the “Happy Birthday” as target media 40 and search for synchronous media 42 related to “Happy Birthday.” For instance, related or synchronous media 42 may include scheduled events, stores, party favors, etc. related to birthdays, famous people sharing a common birthday, places to celebrate a birthday, other friends with the same birthday, etc. In addition, based upon certain algorithms, the related or synchronous media 42 may include similar media that are frequently encountered such as information related to “graduation,” “new babies,” “vacations,” etc. The target media 42 (i.e., the “Happy Birthday” message) and the identified synchronous media 42 is then displayed to the recipient 12′, for instance, on the recipient's page, “wall,” personal inbox, etc.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method for presenting synchronized media in a digital content environment, the method comprising:
identifying a first user event conducted at least partially within an accessible range of the content environment,
analyzing the first user event via a central synchronous management system to extract searching criteria therefrom, the central synchronous management system being disposed in a communicative relation with the content environment and comprising a computer processor and a storage device,
searching within the content environment for synchronous media at least partially related to the first user event, and
displaying the synchronous media within the content environment.

2. The method as recited in claim 1 further comprising searching for synchronous media disposed outside of the digital content environment.

3. The method as recited in claim 2 further comprising defining the first user event as comprising media generated by a first user for display within the content environment.

4. The method as recited in claim 2 further comprising combining the media generated by the first user with the synchronous media for display within the content environment.

5. The method as recited in claim 4 further comprising organizing the order of display of the synchronous media based upon an identified source associated with the synchronous media.

6. The method as recited in claim 5 further comprising organizing the order of display of the synchronous media based upon relevance of the synchronous media as compared to the media generated by the first user.

7. The method as recited in claim 6 further comprising defining the digital content environment as comprising an Internet-accessible social network environment.

8. The method as recited in claim 6 further comprising defining the content environment as comprising a web forum.

9. The method as recited in claim 6 further comprising defining the digital content environment as comprising a mobile electronic communication environment.

10. The method as recited in claim 6 further comprising defining the digital content environment as being electronic mail environment.

11. A method for presenting synchronized media in a computer implemented social network environment, the method comprising:
identifying target media generated by a first user for display within the social network environment,
analyzing the target media via a central synchronous management system to identify searching criteria, the central synchronous management system comprising a computer processor and a storage device,
searching, in real time, for internal synchronous media, the internal synchronous media comprising media disposed within the social network environment and being at least partially related to the target media,
searching, in real time, for external synchronous media, the external synchronous media comprising media disposed external to the social network environment and being at least partially related to the target media,
formatting the order of display of the internal synchronous media and the external synchronous media based upon an identified source and an identified level of relevance to the target media, and
displaying the formatted internal and external synchronous media within the social network environment.

12. The method as recited in claim 11 further comprising communicating the target media to a designated recipient within the social network environment.

13. The method as recited in claim 11 further comprising combining the formatted internal and external synchronous media with the target media and subsequently communicating the combined media to a designated recipient.

14. A system for presenting synchronized media in a digital content environment, the system comprising
a central synchronous management system comprising a computer processor and a memory device,
said central synchronous management system being disposed in a communicative relation with the digital content environment and comprising a synchronous engine structured to receive target media generated by a first user within the digital content environment,
said synchronous engine further structured to analyze said target media to identify searching criteria,
said synchronous engine further structured to search within the digital content environment and outside of the digital content environment with said searching criteria for synchronous media, said synchronous media comprising previously generated media at least partially related to the target media, and
said synchronous engine further structured to communicate said synchronous media to the digital content environment for display therein.

15. The system as recited in claim 14 wherein said synchronous engine is further structured to format said synchronous media based at least in part upon an identified source of said synchronous media and an identified relevance of said synchronous media to said target media.

16. The system as recited in claim 15 wherein said synchronous engine is further structured to combine said target media with said formatted synchronous media and subsequently communicate said combined target and formatted synchronous media to the digital content environment for display therein.

17. The system as recited in claim 16 wherein the digital content environment comprises a computer implemented social network.
